(19) United States
(12) Patent Application Publication
(10) Pub. No.: US 2010/0020444 A1
(43) Pub. Date: Jan. 28, 2010

(54) HEAD SLIDER IN MAGNETIC DISK DRIVE

(75) Inventors: Hiroyuki Kubotera, Kawasaki (JP); Tohru Fujimaki, Kawasaki (JP); Takahiro Imamura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/489,257

(22) Filed: Jun. 22, 2009

(30) Foreign Application Priority Data
Jul. 25, 2008 (JP) 2008-192666

(51) Int. Cl. G11B 5/60

(52) U.S. Cl. 360/235.1; G9B/5.229

(57) ABSTRACT

A head slider in a magnetic disk drive wherein provisions are made to facilitate the evaporation of lubricant adhering to the slider and thereby substantially reduce the chance of the fly height of the slider becoming unstable due to a lubricant drop. A head element, a heat generating element, and a multilayered heat conducting structure formed from multiple layers stacked along a longitudinal direction of the slider, with at least one layer extending up to portions near both lateral sides of the slider, are embedded into a nonmagnetic insulating layer formed in an air exit end portion of the slider. The heat generated by the heat generating element is efficiently conducted throughout the nonmagnetic insulating layer to heat the entire structure of the nonmagnetic insulating layer. As a result, the lubricant adhering to any portion of the nonmagnetic insulating layer is efficiently heated, causing the lubricant to evaporate or flow.

### CROSS-REFERENCE TO RELATED APPLICATIONS

This application is based upon and claims the benefit of priority of the prior Japanese Patent Application No. 2008-192666, filed on Jul. 25, 2008, the entire contents of which are incorporated herein by reference.

### FIELD

The embodiments discussed herein are related to a slider (head slider) with a recording/playback head mounted thereon in a magnetic disk drive.

### BACKGROUND

In recent magnetic disk drives, as recording density increases, it is strongly desired to reduce the distance or magnetic spacing between the recording/playback head (also called the read/write element, head element, or read/write head) and the medium. To achieve this, it is necessary to reduce the fly height of a head slider, i.e., the slider on which the recording/playback head is mounted (refer, for example, to Japanese Laid-open Patent Publication No. 2005-293701). In recent head sliders, the fly height is smaller than 10 nm. However, such small fly heights tend to increase the possibility of the disk lubricant adhering to the head slider.

FIG. 1 is a side view depicting the air exit end portion of a head slider flying over a rotating disk as viewed from the side thereof, revealing the lubricant adhering to the slider. In the figure, reference numeral 102 indicates the slider body formed, for example, from alumina titanium carbide (AlTiC). Reference numeral 104 indicates a portion formed from a nonmagnetic insulating layer where a read/write element 106 is formed. The nonmagnetic insulating layer is formed using, for example, alumina (Al₂O₃). Reference numeral 110 indicates the magnetic disk, and the arrow indicates the direction of rotation of the disk 110.

If the lubricant applied to the disk 110 adheres to the slider for any reason, the lubricant flows over the slider due to the effects of airflow, etc. The flowing lubricant then becomes a lubricant droplet 120 on the flying face near the air exit end, and further becomes a lubricant droplet 122 on the air exit end face.

If the lubricant droplet becomes larger and exceeds a tolerable amount, the lubricant suddenly comes off the slider and drops onto the disk 110 in the form of a lump. Such a phenomenon is called a lubricant drop. After the lubricant drop, if the slider touches the lump of lubricant on the disk 110, the flying state of the slider becomes unstable. In the worst case, a head crash could occur. If the flying state does not become unstable, the magnetic spacing when the slider passes above the affected portion increases due to the thickness of the lubricant drop, which can result in being unable to read or write data.

### SUMMARY

According to one aspect of the technique disclosed herein, a head slider in a magnetic disk drive includes, within a nonmagnetic insulating layer formed in an air exit end portion of the slider, a head element, a heat generating element, and a multilayered heat conducting structure formed from multiple layers stacked along a longitudinal direction of the slider, with at least one layer extending up to portions near both lateral sides of the slider.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a side view depicting the air exit end portion of a head slider flying over a rotating disk as viewed from the side thereof, revealing the lubricant adhering to the slider;

FIG. 2 is a perspective view depicting an overview of the construction of a magnetic disk drive to which a head slider according to the present disclosure is applied;

FIG. 3 is a perspective view, as viewed from the medium side, of the head slider as one example to which the technique disclosed herein is applied;

FIG. 4 is a plan view depicting the air exit end portion of a head slider according to a first embodiment, as viewed from the medium side thereof;

FIG. 5 is a diagram depicting the air exit end face of the head slider according to the first embodiment;

FIG. 6 is a plan view depicting the air exit end portion of a head slider according to a second embodiment, as viewed from the medium side thereof;

FIG. 7 is a plan view depicting the air exit end portion of a head slider according to a third embodiment, as viewed from the medium side thereof; and

FIG. 8 is a diagram depicting a modified example of FIG. 4.

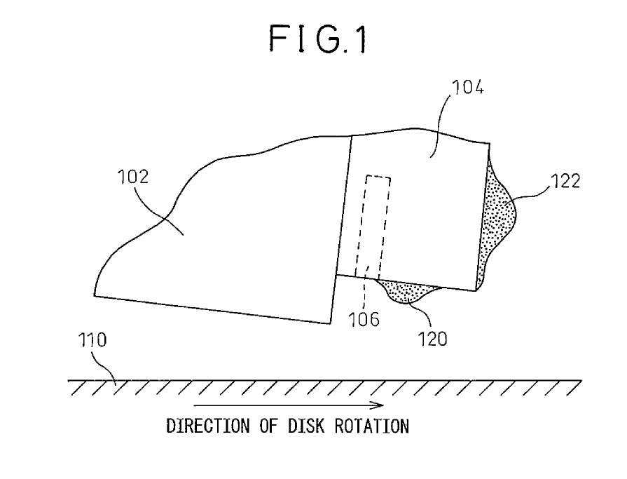

### DESCRIPTION OF EMBODIMENTS

The preferred embodiments of the present invention will be explained with reference to the accompanying drawings.

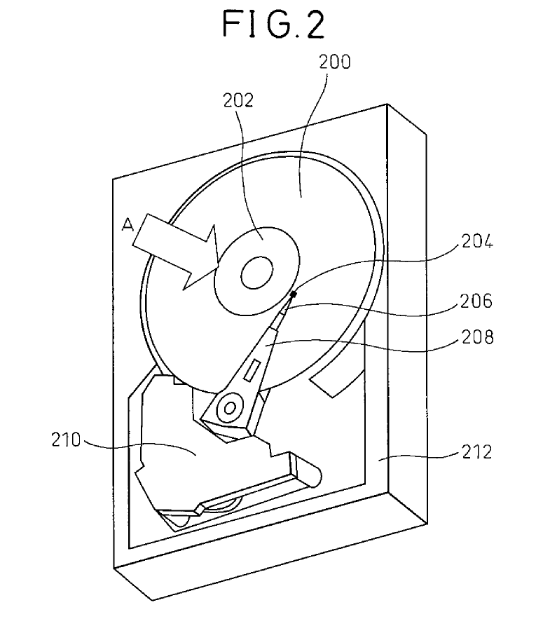

First, an overview of the construction of a magnetic disk drive to which a head slider according to the present disclosure is applied will be given with reference to FIG. 2. A magnetic disk drive is a type of recording apparatus in which the head slider with a head element (also called a recording/playback head, read/write element, or read/write head) mounted thereon flies over a rotating recording medium to read or write data thereon. In FIG. 2, the cover which is installed in the direction indicated by arrow A is removed to reveal the internal construction of the disk drive.

In FIG. 2, the magnetic recording medium (magnetic disk) 200 is fixedly secured to a spindle motor by means of a clamp 202, and in operation, it keeps rotating at a predetermined rotational speed by being driven by a spindle motor. The head slider 204 is aerodynamically-levitated at a height on the order of nanometers above the magnetic recording medium 200. The read/write head mounted on the head slider 204 operates by maintaining a predetermined spacing above the magnetic recording medium 200.

The slider 204 is connected to an actuating arm 208 via a suspension 206 which applies a constant amount of pressing force to the slider 204. With the actuating arm 208 being driven back and forth over the magnetic recording medium 200 by a voice coil motor 210, reading or writing of data at a designated position can be accomplished. Reference numeral 212 indicates a base.

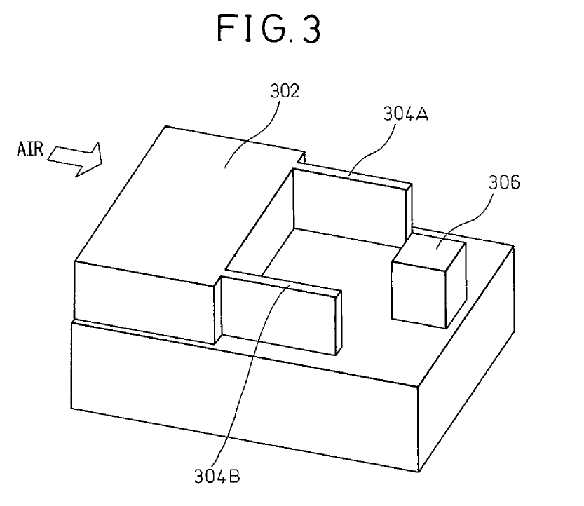

FIG. 3 is a perspective view, as viewed from the medium side, of the head slider as one example to which the technique disclosed herein is applied. In the figure, the steps on the surface are exaggerated in order to facilitate the explanation of the shape, but the actual head slider is substantially rectangular in appearance. The head slider, which is placed so as to face the rotating magnetic disk (magnetic recording medium), is provided, for example, with an air receiving-side pad 302, two side rails 304A and 304B, and a center pad 306 on its surface facing the medium, i.e., the air bearing surface, so as to produce desired positive and negative pressures with respect to the disk by receiving the airflow generated between the disk and the slider. According to the technique disclosed herein, the air exit end portion of the head slider is constructed as will be described hereinafter. However, the technique disclosed herein is not limited to the above pad configuration and air bearing surfaces of various other configurations may be employed.

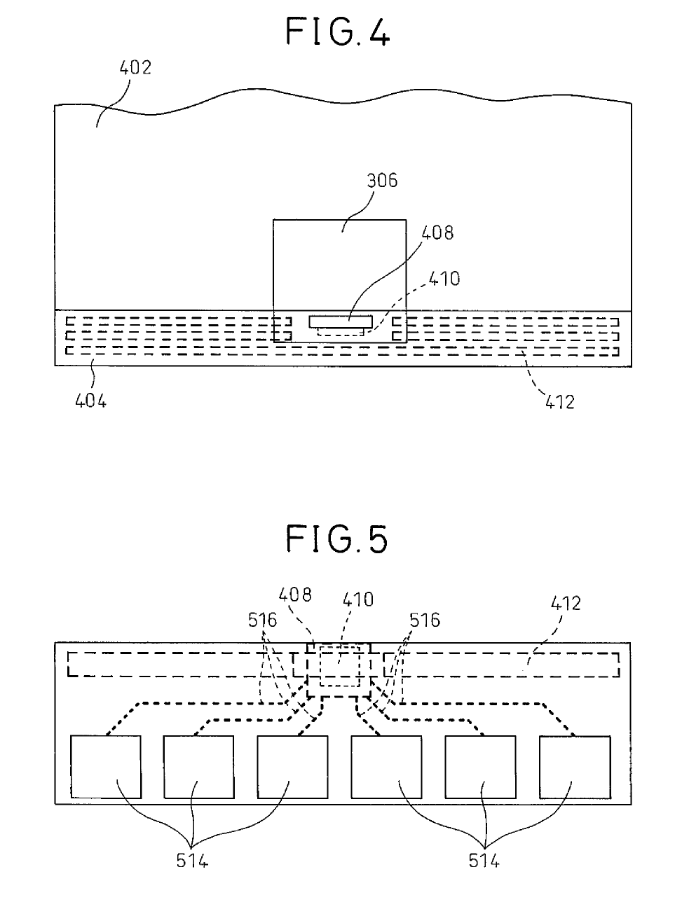

FIG. 4 is a plan view depicting the air exit end portion of a head slider according to a first embodiment, as viewed from the medium side thereof (the flying face of the slider). FIG. 5 is a diagram depicting the air exit end face of the head slider according to the first embodiment. In the figures, reference numeral 306 is the center pad described above, 402 is an alumina titanium carbide (AlTiC) part, 404 is a nonmagnetic insulating layer, 408 is a read/write element, 410 is a heat generating element, 412 is a multilayered heat conducting plate, 514 are contact terminals, and 516 are wiring lines.

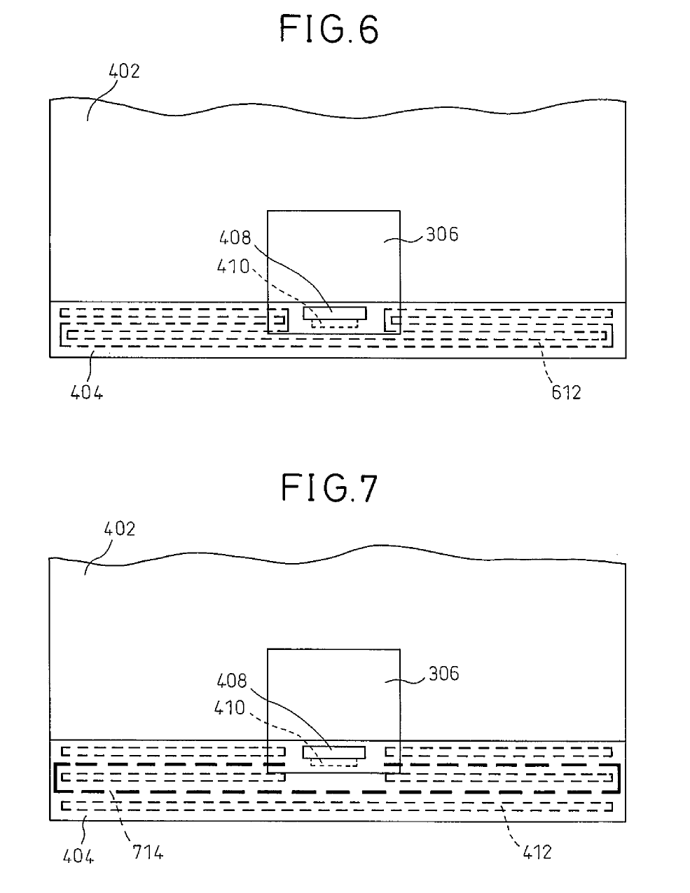

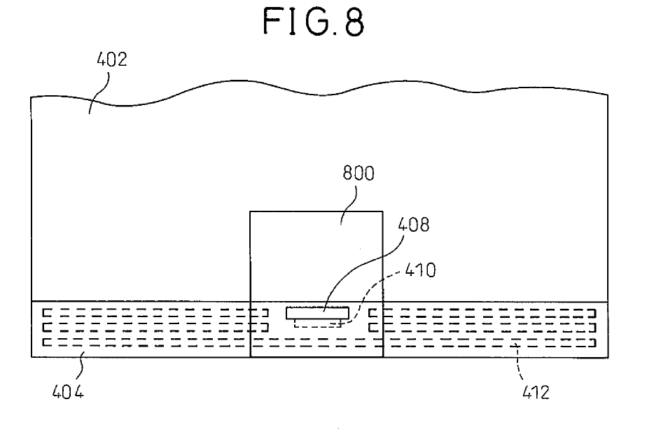

In the example depicted in FIG. 4, a gap is formed between the center pad 306 and the exit end. The lubricant may accumulate in this gap. In view of this, the gap between the center pad 306 and the exit end may be eliminated as depicted in FIG. 8. This also applies to FIGS. 6 and 7 which will be described later.

As depicted in FIG. 4, the nonmagnetic insulating layer 404 formed, for example, from alumina is provided adjacent to the AlTiC part 402. The read/write element 408 is formed within the nonmagnetic insulating layer 404. The heat generating element 410 located adjacent to the read/write element 408 is, for example, a heating wire implemented as a fly height controlling heat generating structure. The fly height controlling heat generating structure achieves the function of lowering the fly height of the slider with respect to the disk by generating heat when energized and thereby causing the slider to expand. Alternatively, the heat generating element 410 may be implemented as a recording coil, incorporated in the read/write element 408, for generating heat in a similar manner.

Two of the six contact terminals 514 depicted in FIG. 5 are contact terminals for reading, two are contact terminals for writing, and the remaining two are contact terminals used when the heat generating element 410 is constructed from the fly height controlling heat generating structure. When the heat generating element 410 is incorporated as a recording coil, four contact terminals 514 will suffice. However, the number and configuration of contact terminals are not limited to those depicted in the above example, and various other contact terminals may be employed.

As depicted in FIGS. 4 and 5, the multilayered heat conducting plate 412 embedded in the nonmagnetic insulating layer 404 is a multilayered heat conducting structure formed from multiple layers stacked along the longitudinal direction of the slider, with at least one layer extending up to portions near both lateral sides of the slider. The multilayered heat conducting plate 412 is preferably formed from a highly heat conducting material such as gold, silver, copper, or aluminum.

In the head slider depicted in FIGS. 4 and 5, the heat generated by the heat generating element 410 is efficiently conducted throughout the nonmagnetic insulating layer 404 via the multilayered heat conducting plate 412, so that the entire structure of the nonmagnetic insulating layer 404 can be heated. As a result, the lubricant adhering to the flying face and the exit end face of the nonmagnetic insulating layer 404 can be evaporated and diffused with a high probability. In particular, not only the lubricant adhering near the center of the slider but also the lubricant adhering to the lateral side faces of the slider can be evaporated, diffused, and caused to vanish with a high probability.

FIG. 6 is a plan view depicting the air exit end portion of a head slider according to a second embodiment, as viewed from the medium side thereof. The second embodiment differs in the following respect from the first embodiment depicted in FIGS. 4 and 5. That is, the multilayered heat conducting plate 612 depicted in FIG. 6 is modified from the multilayered heat conducting plate 412 depicted in FIGS. 4 and 5 by connecting the respective layers. According to the thus modified multilayered heat conducting plate 612, the heat conduction effect increases, and the entire nonmagnetic insulating layer 404 can be heated evenly. The effect can be obtained by connecting at least two layers in the heat conducting plate.

FIG. 7 is a plan view depicting the air exit end portion of a head slider according to a third embodiment, as viewed from the medium side thereof. The third embodiment differs in the following respect from the first embodiment depicted in FIGS. 4 and 5. That is, in the head slider depicted in FIG. 7, a multilayered heat generating plate 714 is additionally embedded in the nonmagnetic insulating layer 404. The multilayered heat generating plate 714 is formed from multiple layers stacked along the longitudinal direction of the slider, with at least one layer extending up to portions near both lateral sides of the slider, and functions as a lubricant evaporating multilayered heat generating structure. The layers forming the multilayered heat conducting plate 412 and the layers forming the multilayered heat generating plate 714 may be arranged alternately with each other as depicted in FIG. 7, or may not be so arranged.

The layers in the multilayered heat generating plate 714, each formed from a high electrical resistance metallic plate, provide electrical paths and, when energized, generate heat to heat the nonmagnetic insulating layer 404. Further, the layers in the multilayered heat generating plate 714 are connected in parallel. The layers need not necessarily be connected in this manner, but the parallel connection simplifies the structure for applying the voltage for energization.

In the head slider depicted in FIG. 7, the entire structure of the nonmagnetic insulating layer 404 is efficiently heated by the multilayered heat conducting plate 412 and the multilayered heat generating plate 714, and the lubricant adhering to the flying face and the air exit end face of the nonmagnetic insulating layer 404 can be evaporated and dispersed with a high probability. In particular, not only the lubricant adhering near the center of the slider but also the lubricant adhering to the lateral side faces of the slider can be evaporated, dispersed, and caused to vanish with a high probability.

In the magnetic disk drive equipped with the head slider according to the above embodiment, it is preferable to drive the heat generating element 410 or the multilayered heat generating plate 714 while the slider is being unloaded. It is also preferable to drive the heat generating element 410 or the multilayered heat generating plate 714 at predetermined intervals of time while the slider is flying.

According to the head slider disclosed herein, since the heat conducting structure is provided, the heat generated by the heat generating element can be efficiently conducted throughout the nonmagnetic insulating layer to heat the entire structure of the nonmagnetic insulating layer. When the entire structure of the nonmagnetic insulating layer is heated, the lubricant adhering to any portion of the nonmagnetic insulating layer is efficiently heated, causing the lubricant to evaporate or flow. As a result, not only the lubricant adhering near the head element on the slider but also the lubricant adhering to the lateral side faces of the slider can be reliably caused to vanish. By causing the lubricant adhering to the slider to vanish, troubles such as head crash, high fly height, etc. caused by the lubricant drop, etc. can be prevented with a high probability.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority and inferiority of the invention. Although the embodiments of the present invention have been described in detail, it should be understood that the various changes, substitutions, and alterations could be made hereto without departing from the spirit and scope of the invention.

What is claimed is:

1. A head slider in a magnetic disk drive, wherein said head slider includes within a nonmagnetic insulating layer formed in an air exit end portion of said slider:
a head element;
a heat generating element; and
a multilayered heat conducting structure formed from multiple layers stacked along a longitudinal direction of said slider, with at least one layer extending up to portions near both lateral sides of said slider.

2. A head slider in a magnetic disk drive as claimed in claim 1, wherein said multilayered heat conducting structure is formed from a highly heat conducting material.

3. A head slider in a magnetic disk drive as claimed in claim 2, wherein said highly heat conducting material is gold, silver, copper, or aluminum.

4. A head slider in a magnetic disk drive as claimed in claim 1, wherein said heat generating element is implemented as a fly height controlling heat generating structure.

5. A head slider in a magnetic disk drive as claimed in claim 1, wherein said heat generating element is implemented as a recording coil.

6. A head slider in a magnetic disk drive as claimed in claim 1, wherein at least two of the layers forming said heat conducting structure are connected together.

7. A head slider in a magnetic disk drive as claimed in claim 1, further including within said nonmagnetic insulating layer a lubricant evaporating multilayered heat generating structure formed from multiple layers stacked along the longitudinal direction of said slider, with at least one layer extending up to portions near both lateral sides of said slider, and wherein the layers forming said heat conducting structure and the layers forming said lubricant evaporating heat generating structure are arranged alternately with each other.

8. A head slider in a magnetic disk drive as claimed in claim 7, wherein at least two of the layers forming said lubricant evaporating heat generating structure are connected together.

9. A magnetic disk drive, wherein a head slider contained in said magnetic disk drive includes within a nonmagnetic insulating layer formed in an air exit end portion of said slider:
a head element;
a heat generating element; and
a multilayered heat conducting structure formed from multiple layers stacked along a longitudinal direction of said slider, with at least one layer extending up to portions near both lateral sides of said slider.

10. A magnetic disk drive as claimed in claim 9, wherein said heat generating element or said lubricant evaporating heat generating structure is driven while said head slider is being unloaded.

11. A magnetic disk drive as claimed in claim 9, wherein said heat generating element or said lubricant evaporating heat generating structure is driven at predetermined intervals of time while said slider is flying.
